(19) United States
(12) Patent Application Publication
(10) Pub. No.: US 2012/0055385 A1
(43) Pub. Date: Mar. 8, 2012

(54) METHOD FOR THE SEPARATION OF GASES

(75) Inventors: Larry Allen Lien, Solana Beach, CA (US); Tony Picaro, Queensland (AU)

(73) Assignee: ECO BIO TECHNOLOGIES PTY LTD, Crawley, Western Australia, WA (AU)

(21) Appl. No.: 13/259,643

(22) PCT Filed: Mar. 26, 2010
(86) PCT No.: PCT/AU10/00356

§ 371 Date: Nov. 22, 2011

(30) Foreign Application Priority Data
Mar. 26, 2010 (AU) PCT/AU2010/000356

(51) Int. Cl. B01D 53/22; F23J 15/02; B01D 53/56; B01D 53/62; B01D 53/48

(52) U.S. Cl. 110/345; 95/49; 95/47; 110/348

(57) ABSTRACT

A method (10) for the separation of gases involving the method steps of: i) passing an exhaust gas stream (27) containing CO₂ through a first membrane separation system (30) to produce a pre-concentrated gas stream (34) containing at least carbon dioxide; and a reject stream; and ii) directing the pre-concentrated gas stream to at least one purification step (50) to produce a purified CO₂ stream (55); wherein, sulphur-containing gases (SOₓ) are also substantially separated from the exhaust gas (27) by the first membrane separation step (30) into the pre-concentrated gas stream (34), and the purified CO₂ stream (55) is substantially free of nitrogen gas.

### FIELD OF THE INVENTION

The present invention relates to an improved method for the separation of gases. In particular, the method of the present invention involves capture of carbon dioxide and other desirable gases and removal of impurities therefrom, using membrane separation

### BACKGROUND ART

Methods for the recovery of carbon dioxide (CO₂) from combustion processes have attracted more attention in recent times due to global warming and the potential for carbon trading. Whilst CO₂ emissions can be reduced by modifying industrial plants and converting to natural gas (rather than the combustion of coal), many organisations understand that CO₂ capture provides better control over how much CO₂ is released to the atmosphere, and potentially greater impact on both capital and operating costs. A number of technologies are known for capturing CO₂; these include cryogenic distillation processes, adsorption and absorption processes and membrane separation.

To date there have been a variety of proposals for carbon sequestration, in more recent years the capture of CO₂ for growing algae has been suggested and implemented. However, algae is not currently a practical solution because of the very large area required to grow the algae. For example, for a 1000 MW power station, over 2000 hectares of algae ponds would be required. The benefit of using CO₂ for algae production is that the quality of the CO₂ stream is not required to be high purity. Some algae processes use flue gas directly which contains between 5-12% (v/v) CO₂ depending on whether the flue gas comes from a gas or coal fired power station. However, a more highly concentrated CO₂ stream would substantially reduce the volume of gases that need to be pumped into the algae ponds and also increase the rate of algae growth.

Other options for CO₂ sequestration include enhanced oil recovery (injecting CO₂ into oil fields to increase oil recovery), enhanced gas recovery (injecting CO₂ into gas fields to increase gas recovery), and geosequestration (CO₂ is injected into deep stable underground formations where it cannot escape), or potentially to inject the CO₂ at great ocean depths. This requires a CO₂ capture process which can produce over 90% CO₂ purity so that the gas can be economically compressed and injected at high pressure.

Membrane separation is one technology that offers a number of benefits over other technologies for CO₂ capture, e.g. amine absorption, including:
a) Lower energy costs. The amine absorption process requires a gas-to-liquid phase change in the gas mixture that is to be separated which adds a significant energy and maintenance costs to the process operating costs; membrane gas separation does not require a phase change and so less energy is required;
b) Smaller capital costs. Gas separation membrane units are smaller than amine stripping plants;
c) Modular construction allows scale-up of membrane processes using multi-stage operations.

Membrane separation to date has involved the use of polymer membranes to separate carbon dioxide from a gas stream, eg in a post-combustion CO₂ capture application the exhaust or flue gas produced from the combustion of a fuel is passed through a membrane to recover the CO₂ into the permeate stream, with Nitrogen and other gases retained as a reject stream. Polymer membranes are preferred because of their selectivity and ease of manufacture.

The economics of a gas separation membrane process is determined by the membrane's transport properties, i.e., its permeability and selectivity for a specific gas in a mixture. An ideal membrane would exhibit a high selectivity and a high permeability. However, for most membranes, as selectivity increases, permeability decreases, and vice versa.

Each gas component in a feed mixture has a characteristic permeation rate through the membrane. The rate is determined by the ability of the component to dissolve in and diffuse through the membrane material.

For common (inert) gases, the permeability coefficient, P, is the product of the diffusion coefficient, D, and solubility constant, S with the common units noted:

P=D.S cm³(STP)/cm²s cm Hg

The separation factor, α, is defined as the ratio of Pi/Pj, where i, j are the gases being separated.

Examples of some specific polymers proposed and/or utilised for gas separation are tabulated in Table 1 with their respective permeability and permselectivity (α) values.

TABLE 1
Permeability and permselectivity data for some specific polymers

| | Permeability (Barrers) | | | | Permselectivity (α) | |
|---|---|---|---|---|---|---|
| Membrane | O₂ | N₂ | CO₂ | CH₄ | O₂/N₂ | CO₂/CH₄ |
| PTMSP | 9710 | 6890 | 37000 | 18400 | 1.41 | 2.01 |
| Poly(4- | 2700 | 1330 | 10700 | 2900 | 2.03 | 1.98 |
| methyl-1- | | | | | | |
| pentyne) | | | | | | |
| Silicone | 781 | 351 | 4550 | 1430 | 2.22 | 3.18 |
| Rubber | | | | | | |
| PPO | 14.6 | 3.5 | 65.5 | 4.1 | 4.17 | 16.0 |
| Poly- | 1.2 | 0.20 | 4.9 | 0.21 | 6.0 | 23.3 |
| sulfone | | | | | | |

PTMSP—poly(trimethyl silyl propyne)
PPO—poly(2,6-dimethyl-1,4-phenylene oxide);
1 Barrer = cm³ (STP)/cm² s cm Hg × 10⁻¹⁰

Data reproduced from:
Robeson, L. M. (1999), Polymer membranes for gas separation, Current Opinion in Solid State and Materials Science, 4, 549-552

Each gas component in a feed mixture has a characteristic permeation rate through the membrane. The rate is determined by the ability of the component to dissolve in and diffuse through the membrane material.

As can be seen in Table 1 some membranes (e.g. polysulfone) show excellent separation factors for O₂/N₂, CO₂/CH₄, but low permeability, while other membranes (e.g. PTMSP) have lower separation factors for these gases but much higher permeability.

Membrane degradation is another important factor in deciding whether a membrane is suitable for a post-combustion CO₂ capture application. The membrane must be chemically and thermally durable to withstand the harsh operating conditions found in a post combustion flue gas such as that produced from a coal fired power station. Some membranes, for example Polysulfone membranes, are very robust and well suited to treating post combustion flue gases. However, these membranes do not have very high CO₂ permeability, whereas other membranes, for example PTMSP have very high CO₂ permeability, but are not robust enough to handle prolonged exposure to a post combustion flue gas.

Typically polymer gas separation membranes are very thin, eg less than 1 micron thick, in order to keep gas permeability as high as possible. As a result the membrane must be reinforced by a backing support or substrate. Depending on the application and/or to keep membrane costs low, these backing materials are typically polymers, eg polysulfone, polyethylene, PVC, cellulose nitrile, etc.

Membrane surface area is another important factor when evaluating the economics of gas separation applications. The amount of surface area needed for a specific application will depend on the number of stages required, the separation factor, membrane material and membrane thickness.

In conventional CO₂ capture processes, particularly membrane processes, the gases are pressurised in order to achieve the required driving force across the membrane. It is estimated that compressors installed to obtain pressurised gas streams can account for over 50% of the capital and operating expenditure in installing CO₂ capture systems.

As outlined above, a substantial problem with CO₂ capture processes is the sheer volume of gas that needs to be handled. The IEA Greenhouse Gas R&D programme in the UK reports that in order for a typical power plant to reduce their CO₂ emissions by 75%, the equipment required would need to be approximately 10 times larger than the plant itself. Clearly the large capital expenditure (CAPEX) required to achieve this is a significant deterrent to organisations for incorporating CO₂ capture processes.

A method for reducing the flue gas volume is to utilise oxyfuel combustion systems which substantially increase the oxygen content in the feed gas stream. Oxyfuel combustion involves combusting a fuel in pure oxygen (or at least 80-100% oxygen). This eliminates the bulk of nitrogen and produces a flue/exhaust gas that has a high CO₂ content (65-95% CO₂). A bleed of the flue gas stream is then recirculated back and combined with the feed gas to moderate combustion temperature, and to upscale the CO₂ content in the flue gas produced. To date, efforts have been focussed on keeping oxygen content in the feed gas high, and maximising the concentration of CO₂ in the flue gas stream (to at least greater than 50%) in order to improve efficiency of these processes and minimise impurities in the gas streams.

Whilst the oxyfuel combustion process improves the CO₂ content of the flue gas stream, the cost of producing large volumes of concentrated oxygen and incorporating such a process into an existing plant is significant. Furthermore, it may not be compatible with existing infrastructure because burners in existing plants may not be able to operate efficiently under such high oxygen gas conditions. Alternatively, the burners themselves may be damaged.

Designing an efficient flue gas separation system is crucial to producing low CAPEX (capital cost) and OPEX (operating cost) processes to address the large volumes of CO₂ produced by power stations.

Before the CO₂ can be captured from a power station flue gas it will be necessary to pre-treat the gas to remove impurities which may interfere with the CO₂ capture process.

Untreated flue gas contains a wide range of chemical components as well as considerable particulate matter. The flue gas dust loading is one important parameter that requires management before the flue gas can be treated in any downstream process, or before it can be released to the atmosphere. Flue gas streams which are prone to be dusty include flue gases produced from burning coal, biomass, or oil. In practice the flue gas is cleaned in a dust removal process, e.g. in a coal fired power station the flue gas is treated in a baghouse or in electrostatic precipitators (ESPs) to remove dust and particulates. After the baghouse the flue gas will typically contain dust levels below 100 mg/N m³, eg typically a dust loading around 10 mg/N m³ is acceptable for the flue gas to be released to the atmosphere.

In some applications depending on the NOx concentration in the original flue gas, NOx removal may be carried out upstream of the dust removal step (eg upstream of the baghouse or ESP) using a selective catalytic reduction (SCR) process.

In a conventional power station flue gas handling circuit cooling may also be incorporated with removal of impurities to streamline the process, eg a flue gas desulphurisation step (FGD) may be performed downstream of the dust removal process, prior to releasing the exhaust gas to the environment. FGD is the technology used for removing sulphur dioxide (SO₂) from the flue gases of power plants or other combustion processes that burn coal or oil. SO₂ is responsible for acid rain and stringent environmental emission regulations have been enacted in many countries to cut SO₂ emissions.

SO₂ is typically removed from flue gases by wet scrubbing using a slurry of limestone or lime to scrub the gases. There are a number of wet scrubber designs that have been used in wet FGD systems, including spray towers, venturis, plate towers, and mobile packed beds. Because of scale build-up, plugging, or erosion, which affects FGD dependability and absorber efficiency, the trend is to use simple scrubbers such as spray towers instead of more complicated ones.

Another complication associated with wet FGD systems is that the flue gas exiting the absorber is cooled to below 100° C., eg typically below 60° C. and is saturated with water as well as still containing some SO₂. This results in the formation of acidic condensate (SO₃/H₂SO₄) which leads to increased chemical corrosion to downstream equipment. To reduce corrosion the scrubbed gases are reheated above the acid dew point of the gas, typically between 80° C. and 140° C., depending on the water content in the scrubbed flue gas. The temperature must be kept high enough to prevent SO₃/H2SO₄ from condensing onto downstream equipment. Reheating increases the energy consumed in the gas treatment process since the majority of the gas is inert N₂ which needs to be reheated before it is ejected from the stack. Reheating is also required for stack gas buoyancy, i.e. to ensure adequate dispersion of the gas leaving the stack.

An alternate option is to choose construction materials and design conditions that allow equipment to withstand the corrosive conditions. However reheating is still required for stack gas buoyancy. The selection of a reheating method or the decision not to reheat is a complex topic associated with the design of an FGD system. Both alternatives are expensive and must be considered on a by-site basis.

The reaction taking place in a wet flue gas scrubber using CaCO₃ (limestone) slurry produces CaSO₃ (calcium sulphite) and can be expressed as:

CaCO₃ (solid)+SO₂ (gas)→CaSO₃ (solid)+CO₂ (gas)

When wet scrubbing with a Ca(OH)₂ (lime) slurry, the reaction also produces CaSO₃ and can be expressed as:

Ca(OH)₂ (solid)+SO₂ (gas)→CaSO₃ (solid)+H₂O (liquid)

To partially offset the cost of the FGD installation, in some designs, the CaSO₃ (calcium sulphite) is further oxidized to produce marketable CaSO₄.2H₂O (gypsum). This technique is also known as forced oxidation:

CaSO₃ (solid)+H₂O (liquid)+½O₂ (gas)→CaSO₄ (solid)+H₂O

After treatment with either limestone or lime slurry the flue gases will contain entrained particles of CaSO₃/CaSO₄ which are highly scaling, making it problematic to feed the gas into any further downstream treatment processes such as a membrane system for recovering CO₂.

An alternate option is to scrub the flue gas with sodium hydroxide which produces a soluble product such as sodium sulphite/bisulphite (depending on the pH), or sodium sulphate, and therefore avoid problems associated with gypsum fouling. However sodium hydroxide is much more expensive than lime or limestone and is seldom used for scrubbing the large flue gas volumes produced from a power station.

Where an amine absorption system is used for post-combustion CO₂ capture a second FGD unit may be required upstream of the amine plant to further reduce the SO₂ to sufficiently low enough levels to prevent degradation of the amine reagent. In addition any particulates remaining in the scrubbed flue gas will build-up within the scrubbing solution and eventually will have to be removed from the system, resulting in a toxic solid waste which must be properly handled and disposed.

Polymer membrane systems also require some form of pre-treatment of the flue gas stream prior to CO₂ separation and capture. The presence of impurities including dust and particulates can foul or block a membrane capture system. There is some concern about the ability of membranes to deal with the dust loadings present in the flue gas streams, even after treatment in a baghouse or ESP.

A gas particle filter can be installed upstream of the membrane system to protect the membranes from the particulates remaining in the flue gas after a baghouse or ESP.

Even with a gas particle filter some dust particles still remain in the flue gas and these can deposit and build-up over time on the membrane surface and foul the membrane.

If the membrane system is installed downstream of an FGD there is the added potential for gypsum particulates to be present in the scrubbed gas which can foul the membranes and make them difficult to clean.

If the membrane can operate at higher temperatures, i.e. at least above 120° C., and preferably above 200° C., and even up to 300° C., then the membrane CO₂ capture system can be installed in front of the FGD unit and thereby eliminate the problems associated with membrane fouling due to gypsum particulates coming from the FGD. In this case the membrane system would have to be operated above the acid dew point of the flue gas, typically between 120 and 200° C., to prevent SO₃/H2SO₄ from condensing and corroding downstream equipment, and thereby reducing the need for expensive materials of construction.

Commonly used polymer backing materials are temperature sensitive, eg polyethylene, PVC, Cellulose Nitrile, typically have normal operating limits up to 100° C. This allows membrane construction costs to be kept low. However flue gases will be hot and need to be cooled prior to feeding the membranes. If higher operating temperatures are required then more temperature resistant backing materials can be used, eg Teflon may be used as the backing material allowing the membrane to operate above 150° C. Above 200° C. more heat resistant polymers may be used as the backing support, eg polysulfone, PVDF (Polyvinylidene Fluoride) or some high temperature Nylons, and can even allow operation up to 300° C. For temperatures over 300° C. a ceramic or metal or metal oxide backing material may be used.

The polymer membrane itself will also have to be capable of withstanding higher temperatures, eg above 120° C. and preferably above 200° C. without suffering degradation.

Furthermore, some commonly used polymeric membranes are hydrophilic. Water vapour needs to be removed prior to CO₂ capture in these instances otherwise the membrane will “wet out” with water and will no longer be gas permeable.

The design of the membrane system must ensure the most suitable membrane materials and membrane construction is used to deal with the flue gas proprieties, including temperature, composition of gas impurities, and particulate loading. The design of the membrane system must also allow for easy cleaning if the membranes do become fouled due to processing dusty streams.

The method of the present invention has one object thereof to substantially overcome one or more of the abovementioned problems associated with the prior art, or to at least provide a useful alternative thereto.

The preceding discussion of the background art is intended to facilitate an understanding of the present invention only. The discussion is not an acknowledgement or admission that any of the material referred to is or was part of the common general knowledge as at the priority date of the application.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

### DISCLOSURE OF THE INVENTION

In accordance with the present invention there is provided a method for the separation of gases comprising the steps of:
i) passing an exhaust gas stream containing CO₂ through a first membrane separation system to produce a pre-concentrated gas stream containing at least carbon dioxide; and a reject stream; and
ii) directing the pre-concentrated gas stream to—at least one purification step to produce a purified CO₂ stream;
wherein, sulphur-containing gases (SOₓ) are also substantially separated from the exhaust gas by the first membrane separation step into the pre-concentrated gas stream, and the purified CO₂ stream is substantially free of nitrogen gas.

Preferably, the first membrane separation system comprises at least one high CO₂ permeability membrane.

Preferably the membranes used in the first membrane separation system have a CO₂ permeability within the range of about 10 to 40,000 Barrer.

More preferably, the membranes used in the first membrane separation system have a CO₂ permeability within the range of about 100 to 10,000 Barrer.

Preferably the membranes used in the first membrane separation system have a SO₂ permeability within the range of about 10 to 60,000 Barrer.

More preferably, the membranes used in the first membrane separation stage have a SO₂ permeability within the range of about 100 to 30,000 Barrer.

More preferably, the membranes used in the first membrane separation system have any one of a flat sheet or spiral wound construction.

The membrane/s of the first membrane separation system preferably comprise a polymer membrane made from any one of the following groups of polymers including polysulfones, polyacetylenes, polysiloxanes, poly-arylates, polycarbonates, poly(aryl ethers), poly(aryl ketones) or polyimides, or a blend thereof.

Alternatively, the membrane/s of the first membrane separation system comprise an inorganic membrane comprising a ceramic, or metal or metal oxide.

More preferably, the membrane/s of the first membrane separation system are formed from any one of the following groups of polymers including polyimides, polysiloxanes, polyacetylenes, or poly(phenylene oxides), or a blend thereof

Still preferably, the membrane of the first membrane separation system are formed from polydimethyl siloxane (PDMS).

Preferably the purification step comprises at least one membrane.

Preferably, the membrane/s of the purification step have a higher selectivity for CO₂ over nitrogen, compared to the membranes used in the first membrane separation system.

Preferably the membrane selectivity for CO₂ over nitrogen is within the range of 4 to 200. More preferably, the membrane selectivity for CO₂ over nitrogen is within the range of 8 to 100.

More preferably, the membrane/s of the purification step have a hollow fibre construction. Alternatively, they could be in the form of tubular, flat sheet or spiral membranes.

The membrane/s of the purification step are preferably in the form of either natural rubber or cellulose acetate membranes, or other polymers including polysulfones, polyacetylenes, polysiloxanes, poly-arylates, polycarbonates, poly(aryl ethers), poly(aryl ketones) or polyimides, or a blend thereof. Alternatively, the membrane/s of the first membrane separation system comprise an inorganic membrane comprising a ceramic, or metal or metal oxide.

More preferably, the membrane/s of the purification step are formed from any one of the following groups of polymers including natural rubber, cellulose acetate, or polyimides, polysiloxanes, polyacetylenes, or poly(phenylene oxides), or a blend thereof

The purification step is preferably operated at a temperature less than about 100° C.

Preferably, the purity of the purified CO₂ stream is such that it contains at least about 70%-99% (v/v) CO₂.

More preferably, the purity of the purified CO₂ stream is such that it contains at least about 90%-95% (v/v) CO₂.

Preferably, the operating pressure through the first membrane separation system is within the range of about 0.1 bar to 100 bar (absolute).

More preferably, the operating pressure of the first membrane separation system is within the range of about 0.1 bar to 10 bar (absolute).

The operating pressure of the purification step is preferably within the range of about 0.1 bar to 100 bar (absolute).

More preferably, the operating pressure of the purification step is less than about 10 bar.

Preferably, the first membrane separation system is capable of retaining between about 95% and 100% of dust and particulate matter contained in the exhaust gas stream.

More preferably, the first membrane separation system is capable of retaining over 99% of dust and particulate matter contained in the exhaust gas

Preferably, the first membrane separation system retains at least about 50% of the nitrogen contained in the exhaust gas stream.

More preferably, the first membrane separation system retains between about 60% to 90% of the nitrogen contained in the exhaust gas stream into a reject stream.

The membranes of the first membrane separation system are preferably capable of use in high temperature applications.

More preferably, the first membrane separation step comprises at least one high temperature membrane formed from a polymer membrane coated onto a high temperature tolerant backing support or substrate.

Preferably the substrate is in the form of an inorganic substrate.

More preferably, the substrate is in the form of any one of a ceramic, carbide, nitride, sintered metal, metal alloy or oxide.

Still further preferably, the substrate is formed from any one or more of alumina, titanium dioxide, silicon dioxide, zirconium dioxide, silicon carbide, silicon nitride, aluminium, or stainless steel.

Alternatively, the substrate is in the form of a high temperature polymeric substrate, for example any one of Teflon, polysulfone, PVDF or high temperature Nylons.

The use of a membrane with an inorganic substrate or a high temperature polymeric substrate is particularly advantageous as it significantly improves the temperature tolerance of the membrane separation process.

The temperature of the exhaust gas passing through the first membrane separation system is preferably within the range of about 50° C. and 300° C.

More preferably, the temperature of the exhaust gas passing through the first membrane separation system, is kept above the acid dew point of the flue gas, i.e. within the range of about 120° C. and 250° C.

Advantageously, the membrane/s of the first membrane separation system is capable of withstanding temperatures above 120° C. and preferably above 200° C. without suffering degradation.

Advantageously, the method of the present invention does not require the exhaust gas to pass through a cooling and/or desulphurisation step prior to CO₂ separation. This is particularly beneficial as it reduces the instance of membrane fouling due to gypsum produced in, for example an FGD process.

Preferably, the CO₂ concentration in the exhaust gas stream is within the range of about 1% and 50% (v/v).

More preferably, the CO₂ concentration in the exhaust gas stream is within the range of about 2% and 20% (v/v).

Preferably about 70% to 95% of CO₂ present in the exhaust gas stream is separated into the pre-concentrated gas stream.

More preferably, at least about 90% of the CO₂ present in the exhaust gas stream is separated into the pre-concentrated gas stream.

Preferably, at least about 70% to 99% of the SOx in the exhaust gas is separated into the pre-concentrated gas stream.

More preferably, about 90% to 95% of the SOx present in the exhaust gas is separated into the pre-concentrated gas stream.

Preferably, SOx is predominantly comprised of SO₂.

Preferably, at least about 30% to 90% of the nitrogen containing gases (NOx) in the exhaust gas stream is separated into the pre-concentrated gas stream.

More preferably, about 50% to 80% of the NOx present in the exhaust gas stream is separated into the pre-concentrated gas stream.

Preferably, NOx comprises predominantly one or more of NO, N₂O and NO₂.

Preferably the membranes used in the first membrane separation system have a NOₓ permeability within the range of about 10 to 20,000 Barrer.

More preferably, the membranes used in the first membrane separation stage have a NOₓ permeability within the range of about 100 to 10,000 Barrer.

Preferably, at least about 30% to 90% of the water vapour in the exhaust gas is separated into the pre-concentrated gas stream.

More preferably, about 40% to 80% of the water vapour present in the exhaust gas is separated into the pre-concentrated gas stream.

The pre-concentrated gas stream preferably has a volume within the range of about 10% to 60% of the original exhaust gas volume.

More preferably, the pre-concentrated gas stream has a volume within the range of about 20% to 40% of the original exhaust gas volume.

Preferably the membranes used in the first membrane separation system have a H₂O permeability within the range of about 10 to 100,000 Barrer.

More preferably, the membranes used in the first membrane separation stage have a H₂O permeability within the range of about 100 to 50,000 Barrer.

In another form of the invention the pre-concentrated gas stream, is preferably directed to a gas cooling step prior to the purification step.

The condensate stream is preferably directed to an acid reverse osmosis step to produce concentrated acid and a purified water stream.

Preferably, at least a portion of the water stream produced in the reverse osmosis step is recirculated for various purposes, including but not limited to, any one or more of heat exchange in the combustor, process water makeup for plant operations or potable water production.

Preferably, the exhaust gas stream is drawn through the first membrane separation system and purification step under at least, partial vacuum.

Preferably, the exhaust gas is a flue gas.

In accordance with a further aspect of the present invention there is provided a method for the separation of gases comprising the steps of:
i) combusting a gas in a combustor in the presence of a fuel to produce an exhaust gas stream;
ii) passing the exhaust gas stream containing CO₂ through a first membrane separation system to produce a pre-concentrated gas stream containing at least carbon dioxide; and a reject stream; and
iii) directing the pre-concentrated gas stream to at least one purification step to produce a purified CO₂ stream;
wherein, sulphur-containing gases (SOₓ) are also substantially separated from the exhaust gas by the first membrane separation step into the pre-concentrated gas stream, and the purified CO₂ stream is substantially free of nitrogen gas.

Preferably, the combustion process involves the combustion of a carbon-containing fuel.

In accordance with a further aspect of the present invention there is provided a method for the separation of gases involving the method steps of:
i) enriching the oxygen content of a combustion gas entering a combustor to form an enriched oxygen stream;
ii) combusting the combustion gas, in the presence of a fuel to produce an exhaust gas stream;
iii) passing the exhaust gas stream through a first membrane separation system to produce a pre-concentrated gas stream; and
iv) directing the pre-concentrated gas stream to at least one purification step to produce a purified CO₂ stream;
wherein, sulphur-containing gases (SOₓ) are also substantially separated from the exhaust gas by the first membrane separation step into the pre-concentrated gas stream, and the purified CO₂ stream is substantially free of nitrogen gas.

Oxygen enrichment is preferably performed using a membrane system.

The concentration of the enriched oxygen stream is preferably within the range of about 22% to 50% (v/v).

More preferably, the concentration of the enriched oxygen stream is within the range of about 22% to 40% (v/v).

### BRIEF DESCRIPTION OF THE DRAWINGS

The present invention will now be described, by way of example only, with reference to seven embodiments thereof and the accompanying figures, in which:

FIG. 1 is a diagrammatic representation of a flow sheet depicting a method for the separation of gases in accordance with a first embodiment of the present invention.

FIG. 2 is a diagrammatic representation of a flow sheet depicting a method for the separation of gases in accordance with a second embodiment of the present invention.

FIG. 3 is a diagrammatic representation of a flow sheet depicting a method for the separation of gases in accordance with a third embodiment of the present invention.

FIG. 4 is a diagrammatic representation of a flow sheet depicting a method for the separation of gases in accordance with a fourth embodiment of the present invention.

FIG. 5 is a diagrammatic representation of a flow sheet depicting a method for the separation of gases in accordance with a fifth embodiment of the present invention.

### BEST MODE(S) FOR CARRYING OUT THE INVENTION

A number of embodiments of the present invention will now be described. Like numbers are understood to represent like features.

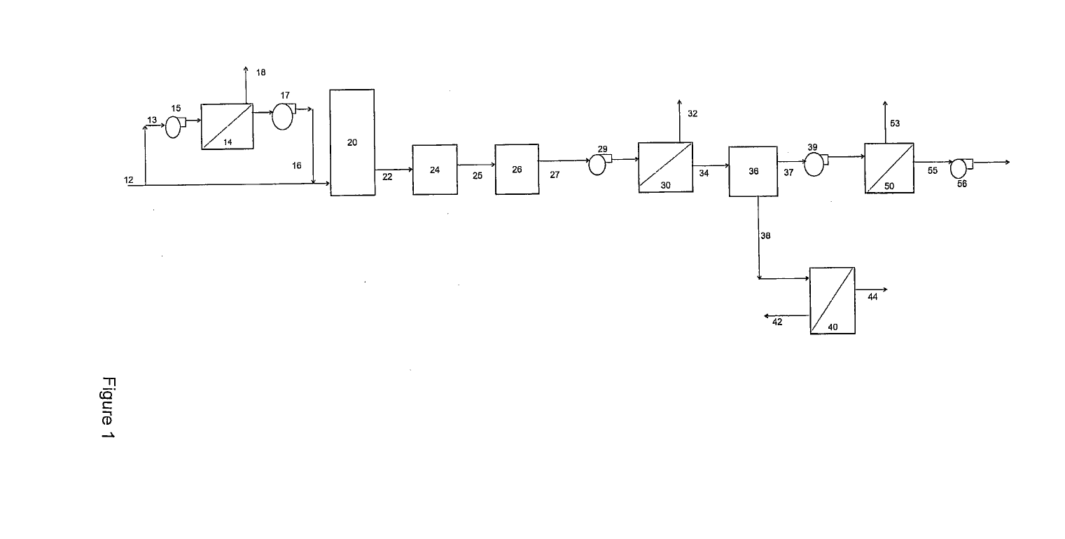

In FIG. 1 there is shown a flowsheet for a method 10 for recovering carbon dioxide in accordance with the present invention.

A combustion gas stream 12 for example, air, is enriched with oxygen by feeding a side-stream 13 through at least one O₂ enrichment membrane 14, for example, about 3 to 4 O₂ enrichment membranes in series or parallel. The O₂ enrichment membrane/s 14 are known in the art, preferably in the form of either polysulfones, polyacetylenes, polysiloxanes, poly-arylates, polycarbonates, poly(aryl ethers), or poly(aryl ketones), or ceramic membranes including for example mixed oxides of Sr—Fe—Co. This produces an oxygen enriched stream 16 having an oxygen content within the range of about 22% to 50% (v/v), for example 22% to 40% (v/v), and an oxygen depleted stream 18. The side-stream 13 is pumped through the O₂ enrichment membrane 14 at slightly greater than atmospheric pressure using a positive displacement pump 15, for example, an air blower. A second pump 17 situated after the O₂ enrichment membrane/s 14, is used to create a vacuum to draw the side-stream 13 through the O₂ enrichment membrane/s 14, forming the oxygen enriched stream 16. The process of enriching the oxygen content in the combustion gas stream 12 also has the effect of reducing the volume of an exhaust gas 22 produced.

The oxygen enriched stream 16 is then combined with the combustion gas stream 12 and directed to a combustor 20, for example a boiler, where it is consumed as an oxidant in the combustion of a fuel, for example a carbon-containing fuel, such as coal. The combustion produces an exhaust gas stream 22 which exits the combustor 20. The exhaust gas stream 22 contains carbon dioxide (CO₂), together with a number of contaminants, including sulphur containing gases (SOx) and nitrogen containing gases (NOx), and water vapour. The concentration of CO₂ in the exhaust gas 22 can be as low as 1%, for example within the range of about 1% and 50% (v/v), for example, 2% and 20% (v/v).

The exhaust gas 22 undergoes for example, a NOx removal step 24, and a dust removal step 26 using known methods, for example selective catalytic reduction (SCR) for NOx removal and a baghouse for dust removal. However, these steps are optional and their inclusion will depend upon the composition of the exhaust gas 22 produced in the combustion process and the desired quality of the exhaust gas. For example a baghouse would typically be used when coal is the fuel, as the exhaust gas 22 and 25 would contain a substantial amount of dust material, whereas it is unlikely that a gas fired boiler would need dust removal.

Using a third positive displacement pump 29, the exhaust gas 27 is then pumped through at least one membrane in a first membrane separation step 30, which is capable of separating at least CO₂ from the exhaust gas 27. For example the membrane separation step 30 may comprise between 1 and 4 membranes inclusive, operating in series. The exhaust gas 27 is simultaneously being drawn under at least partial vacuum by a fourth pump 39 located downstream from a first membrane separation system 30.

In addition to CO₂, the membrane/s is capable of separating SOx, NOx and water vapour from the exhaust gas stream 27, where SOx is primarily in the form of SO₂ and NOx is primarily in the form of NO, N₂O or NO₂. The membrane/s of the first membrane separation system 30 is ideally in the form of a polymer, such as a polysulfone, polyacetylene, polysiloxane, poly-arylate, polycarbonate, poly(aryl ether), poly(aryl ketone) or polyimide, for example polydimethyl siloxane, or a blend of two or more of these polymers. Alternatively, the membrane is an inorganic membrane, for example in the form of, a ceramic or metal, or metal oxide.

The polydimethyl siloxane (PDMS) membrane offers both high flux and good separation factors for CO₂ vs. N₂, as well as good thermal and chemical stability. PDMS is generally non-reactive, stable, and resistant to extreme environments and temperatures from −55° C. to +300° C. with minimal to no degradation. It is difficult to wet the PDMS surface therefore making it resistant to adsorption of impurities onto the surface. PDMS has complete hydrophobicity which prevents condensed water vapour from effecting performance as water will roll off the membrane surface. These properties are significant foroperating in the extreme conditions found in a post combustion exhaust gas.

PDMS also has high permeability for a number of the other gaseous components found in the exhaust gases produced from a combustion process. PDMS has a permeability for SO₂ of approximately 15,000 Barrer, and for NOx the permeability ranges from 600 Barrer for NO up to 7,500 Barrer for NO₂, and for water vapour the permeability is approximately 36,000 Barrer.

If high temperatures are applicable to the process, then the membranes of the first membrane separation system 30 may comprise polymer membranes coated onto a high temperature tolerant substrate, for example an inorganic substrate. Suitable inorganic substrates include ceramic, carbide, nitride, sintered metal, metal alloy or oxide, for example, alumina, titanium dioxide, silicon dioxide, zirconium dioxide, silicon carbide, silicon nitride or stainless steel. Alternatively, the substrate is in the form of a high temperature polymeric substrate, for example, Teflon polysulfone, PVDF or high temperature Nylons.

Flat plate and spiral wound membranes have been made using a polymer membrane coated onto an inorganic backing material such as sintered stainless steel or etched aluminium. Another option is to use an inorganic support which is in the form of a honeycomb monolith. The polymer membrane can be coated onto the inside of the honeycomb structure to achieve the high membrane surface area, i.e. the honeycomb monolith structure will still allow a large membrane area per unit volume required for the first stage of the gas separation process whilst also providing a compact and relatively inexpensive membrane module.

As a result of the use of a backing material that can withstand high temperatures, the CO₂ removal membrane is able to tolerate much higher temperatures than the typical polymer membranes used in the prior art (that is, most polymer membranes can only tolerate up to 100° C., and for a cellulose acetate membrane, less than 50° C.). For example, the membrane material of the first membrane separation system 30 is able to tolerate an exhaust gas stream 27 having a temperature within the range of about 50° C. and 300° C., such as 120° C. and 250° C., i.e. the temperature of the exhaust gas passing through the first membrane separation system 30 is kept above the acid dew point of the flue gas.

This provides a significant advantage in that the exhaust gas 27 is not required to undergo cooling or exhaust gas desulphurisation (FGD) prior to the first membrane separation system 30. Installing an FGD upstream of the membrane can result in fouling of the membrane due to the production of gypsum particles which are formed in the FGD process.

Alternatively, the entire process can be operated at low temperatures (for example less than 100° C.), in which case membranes with inorganic substrates would not be required and a low temperature polymeric backing material could be used, eg polyethylene, PVC, or cellulose nitrile with the benefit of reducing the membrane module costs. However, operating below the flue gas acid dew point may lead to corrosion problems within the membrane system and further downstream. The construction costs can be minimised by cooling the gas below 60° C., for example below 50° C. which then allows the use of acid resistant plastics such as PVC and HDPE (high density polyethylene) for the key construction items such as piping, valves, etc, and thereby reduces capital and operating/maintenance costs. This use of such plastics for construction is also made possible since the operating pressures are not very high.

The design of the first membrane separation system 30 is optimised to be able to handle ‘dusty’ streams i.e. streams that contain particulates as would be supplied from a coal fired power station. These particles can block the membrane flow area, however the possibility of blockage is much lower for spiral-wound membranes than for hollow-fiber membranes, which have a low flow area. Consequently spiral wound membrane construction is preferred to other constructions for the first membrane separation system 30 because of the flexibility to choose suitable feed channel spacing and feed channel separation material to better handle dust and particulates in the exhaust gas stream 27. This reduces the chance of blockages of the membrane and it is also easier to clean the membrane if they become dirty. The spiral membrane construction also offers the least flow resistance, which means less driving pressure, and therefore lower energy consumption and lower operating costs. This factor is important for the first membrane separation system 30 since this will handle the greatest volume of gas.

A flat sheet membrane construction may also be used as it also offers similar benefits to the spiral wound construction.

The first membrane separation system 30 uses membranes with a CO₂ permeability between 10 to 40,000 Barrer, for example between about 100 to 10,000 Barrer.

The first membrane separation system 30 thus retains about 95% to 100% of particulates present, for example over 99%, and retains at least about 50%, for example about 60% to 90% of the nitrogen present in the exhaust gas stream 27. However, it allows other gases, for example CO₂ to pass through it to form a pre-concentrated gas stream 34. The operating pressure of the first membrane separation system 30 is within the range of about 0.1 bar to 100 bar (absolute), for example about 0.1 bar to 10 bar (absolute).

The first membrane separation system 30 utilises membrane materials having higher CO₂ permeability and lower CO₂/N₂ selectivity compared to the second membrane stage 50. For example the membrane used in the first membrane separation system 30 may have double the CO₂ permeability, compared to the membrane used in a purification step 50, for example 1000 Barrer vs. 500 Barrer, but half the CO₂/N₂ selectivity that the membranes of the purification step would have, for example a selectivity value of 10 in the first membrane separation system 30 vs. a selectivity value of 20 in the purification step 50.

The membranes of the first membrane separation system 30 and/or the purification step 50 are formed from, for example any one of a polysulfone, polyacetylene, polysiloxane, poly-arylate, polycarbonate, poly(aryl ether), poly(aryl ketone) or polyimide, or a polymer blend of two or more of these polymers. The purification step 50 may also comprise natural rubber or cellulose acetate membranes, although these are not suitable for the first membrane separation system 30.

Alternatively the membrane/s of the first membrane seaparation system 30 and purification step 50 are formed from inorganic ceramic, or metal, or metal oxide.

The first membrane separation system 30, utilises membrane constructions which offer a low manufacturing cost as well as ease of construction, and a compact design. A spiral membrane construction is best suited to provide these attributes.

After the first membrane separation system 30 a reject gas stream 32, containing substantially all of the N₂ originally present in the exhaust gas stream 27 is exhausted directly to atmosphere.

This provides an advantage over known processes as the exhaust gas 27, does not need to be cooled by passing it through an FGD process, which would then normally require the treated gas to be reheated before the reject gas stream 32 can be exhausted to atmosphere via a stack. A pre-concentrated gas stream 34, containing at least about 70% to 95%, for example at least 90% of the CO₂ and about 70 to 99%, for example about 90% to 95% of the SOₓ, originally present in the exhaust gas stream 27, is produced from the first membrane separation system 30. The pre-concentrated gas stream 34 contains between about 30% to 90% of the water vapour originally present in the exhaust gas stream 22, for example between about 40% and 80%. The pre-concentrated gas stream 34 contains between about 30% to 90% of the NOx originally present in the exhaust gas stream 22, for example between about 50% to 80%. The pre-concentrated gas stream 34 has a volume within the range of about 10 and 60% of the original exhaust gas stream 22, for example within the range of about 20 to 40%.

The reject gas stream 32 comprises about 50% to 90% of the original volume of the pre-concentrated gas stream 34, and it contains about 90 to 95% of the nitrogen originally present in the exhaust gas stream 27. The reject gas stream 32 may be directly vented to atmosphere depending on its composition and/or emission limits for the process.

In accordance with a first embodiment of the present invention, as shown in FIG. 1, the pre-concentrated gas stream 34 is then directed to a gas cooling step 36 where condensed water vapour stream 38, containing dissolved SO₂, is separated from the pre-concentrated gas stream 34. That is, SO₂ in the pre-concentrated gas stream will be absorbed into the condensed water vapour stream 38 to form sulphurous and/or sulphuric acid.

A CO₂ gas stream 37 comprising at least about 40-80% CO₂ (v/v) for example 60% CO₂ (v/v), exits the gas cooling step 36 and is then directed to a purification step 50. The reduced volume of the pre-concentrated gas stream 34 provides a significant advantage in that a smaller volume results in a lower heat load for cooling the gas to remove impurities compared to having to treat the entire flue gas. This in turn results in a more compact and energy efficient gas cooling step 36. The lower heat load required is also a result of the fact that minimal N₂ is present in the pre-concentrated gas stream 34, having been drawn off in the reject gas stream 32. The reject stream 32, containing substantially nitrogen gas and dust particulates, is directed to waste.

The condensed water vapour stream 38, containing sulphuric acid and sulphurous acid, proceeds to an acid reverse osmosis step 40 of type known in the art which produces a concentrated acid stream 42 and a purified water stream 44. The purified water stream 44 can be recirculated for use in the combustor 20, for example in the heat exchangers of a boiler, or for potable water production or as process water for cooling towers. The concentrated acid 42 produced in the reverse osmosis step 40 can be sold commercially or used in other processes if required. As the SO₂ is recovered in the form of sulphuric acid, significant cost savings are realised as the consumption of lime in traditional exhaust gas desulphurization processes is reduced or substantially eliminated.

The purification step 50 has at least one membrane preferably having a hollow fibre construction, which provides for greater surface area per unit volume than the spiral wound or flat sheet construction used in stage 1. As such, it is understood that the membranes of the purification step 50 may have a higher selectivity for CO₂ over Nitrogen, compared to the membranes in the first membrane separation system 30, and consequently a lower CO₂ permeability, compared to the first stage membranes in the first membrane separation system 30, in order to facilitate a higher degree of purification of the CO₂. For this reason the hollow fibre construction is the preferred membrane construction for the second stage as this affords a greater membrane area per unit volume.

Alternatively, the membranes of the purification step 50 may have a tubular, flat sheet or spiral wound construction, depending on the system requirements.

The purification step 50 is operated at a lower temperature than the first membrane separation system 30, for example less than about 200° C., such as less than about 100° C. Cooling the pre-concentrated gas stream 34 reduces the gas volume to be treated in the purification step 50. Furthermore, cooling the pre-concentrated gas stream 34 will remove water vapour and other impurities and thereby further reduces the gas volume in 34. The reduced gas volume means the size of the purification step 50 will be smaller and therefore a more expensive membrane construction, e.g. hollow fibre may be used in addition to a more expensive membrane material, providing higher CO₂ selectivity over nitrogen. Also the purification step 50 can use a membrane material which may be less chemically or thermally durable to the conditions of the flue gas stream 27, compared to the membrane material used in the first membrane separation system 30.

The reduction in volume and the reduced water vapour content in the pre-concentrated gas stream 34 results in an increase in CO₂ concentration. The purification step 50 results in the formation of a purified CO₂ stream 55, which contains at least about 70%-99% (v/v) CO₂, for example at least about 90%-95% (v/v) CO₂. The purified CO₂ stream is sufficiently concentrated so as to be suitable for, for example, algae production, or enhanced oil recovery or to feed an amine absorption unit or a cryogenic distillation unit to produce pure CO₂ for geosequestration. The operating pressure of the purification step 50 is within the range of about 0.1 bar to 100 bar (absolute), for example less than about 10 bar (absolute).

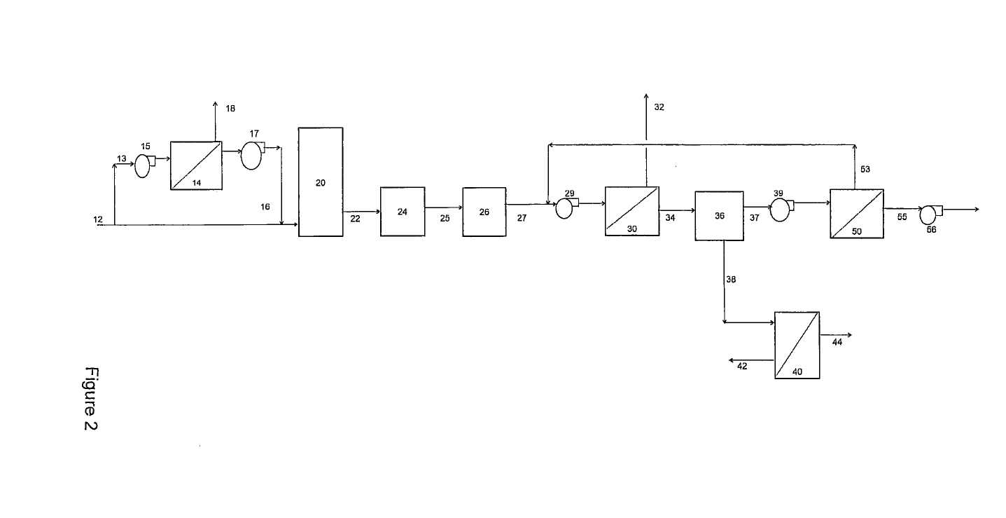

In FIG. 2 there is depicted a second embodiment of the present invention in which a primary retentate stream 53 produced in the purification step 50, which may contain some CO₂, is recycled to combine with the exhaust gas stream 27, so as to be re-treated in the first membrane stage 30 to recover additional CO₂ from stream 53.

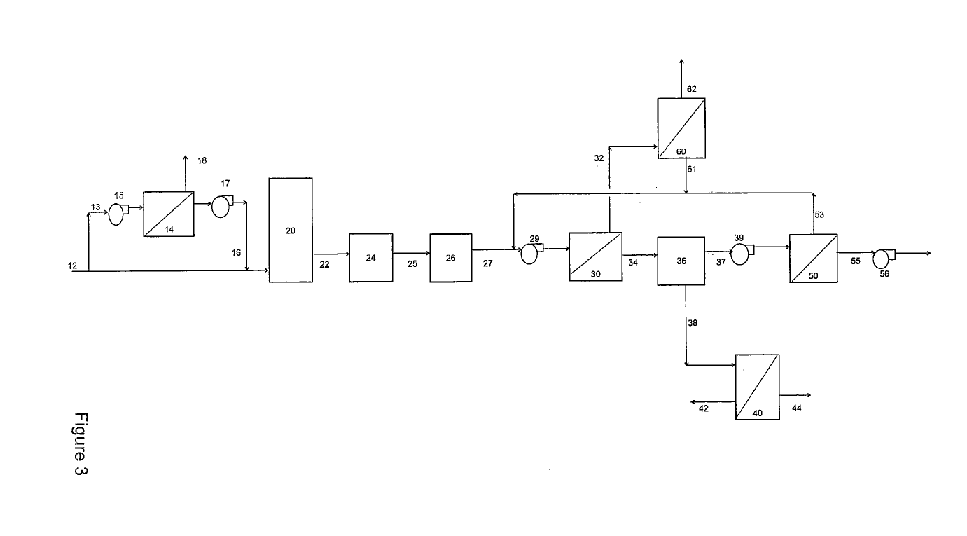

In FIG. 3 there is depicted a third embodiment of the present invention in which the reject stream 32, exiting the first membrane separation step, is directed to an intermediate CO₂ recovery step 60 to capture any CO₂ that might be lost. A secondary retentate stream 62 exiting the intermediate CO₂ recovery step 60 comprises primarily nitrogen gas and dust particulates, and the permeate stream 61 contains a sufficient concentration of CO₂ to be combined with the primary retentate stream 53 for re-treatment to recover more CO₂.

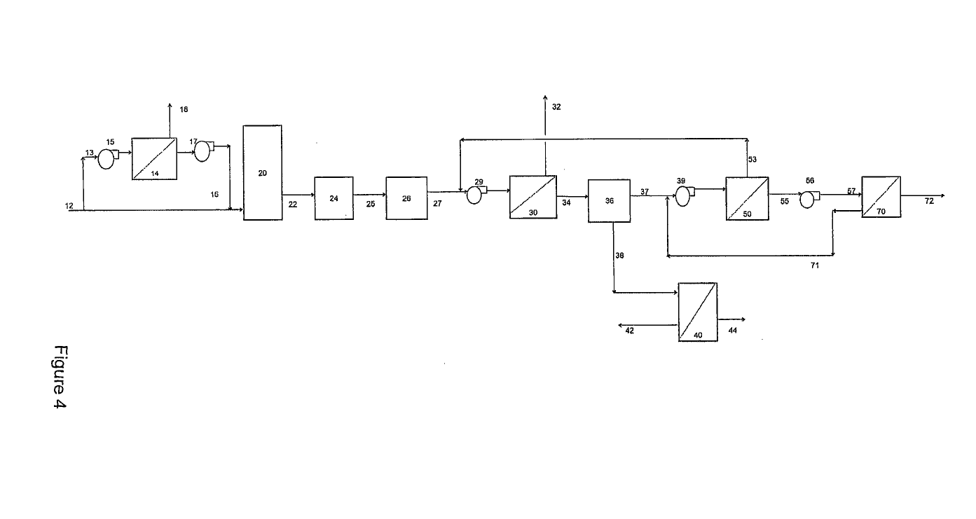

FIG. 4 depicts a fourth embodiment incorporating a second purification step 70, through which the purified CO₂ stream 55 is passed. A secondary purified CO₂ stream 72 is produced which contains at least about 80% to 99% (v/v) CO₂. A third retentate stream 71 can be recycled to be combined with the cooled, pre-concentrated gas stream 37 and passed again through purification steps 50 to recover additional CO₂.

The second purification step 70 can be an ultra high selectivity membrane having any one of spiral, hollow fibre, tubular, ceramic or flat sheet construction, to further concentrate the small volume of enriched CO₂ from the purification step 50 efficiently to a very high CO₂ concentration, for example at least about 90% to 97%. The volume of the third retentate stream 71 directed to the second purification step 50 has been significantly reduced compared to the original volume of the exhaust gas stream 27, for example, to about 20-40% of the original feed volume, such as 10-20% of the original volume of the exhaust gas stream 27. This allows for using a membrane material with very high selectivity for CO₂ while having a lower permeability.

The membrane construction can be optimised to offer high surface area to overcome the lower permeability of the membrane, and it can be possible to utilise a membrane system which requires higher operating pressures than the first membrane separation system 30, for example a hollow fibre membrane construction is preferred. The purified CO₂ stream 72 would contain preferably 90-99% (v/v) and preferably at least 95% (v/v) CO₂ and then fed into an amine absorption process or a cryogenic distillation process which is used to produce pure CO₂ for geosequestration.

Alternately, depending on the gas composition of the purified CO₂ stream 55, the second purification step 70 could be an amine absorption process or a cryogenic distillation process to produce substantially pure CO₂ for geosequestration or other processes requiring substantially pure CO₂.

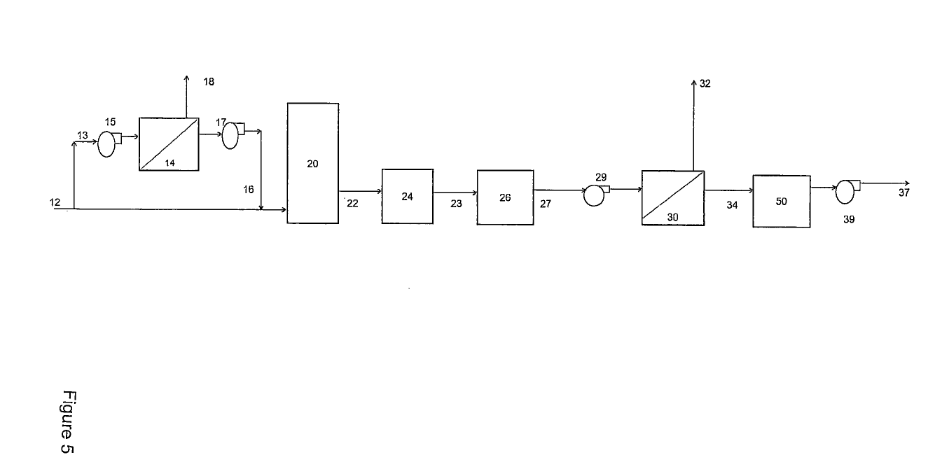

In FIG. 5 there is shown a fifth embodiment of the present invention where the exhaust gas 27 contains high levels of SO₂ for example, greater than about 0.1% (v/v) SO₂ or where downstream processes require low levels of SO₂ in the gas stream, for example less than about 100 ppm. In these circumstances, the pre-concentrated gas stream 34 proceeds to a purification step 50, which is in the form of a SOₓ removal step, for example an FGD process, where the SO₂ is converted to CaSO₄.2H₂O which can then be sold for building materials, or a combined SOx/NOx removal process, eg using an ammonia scrubbing process to produce ammonium sulphate and ammonium nitrate which can be sold for fertiliser.

As a result of the reduced volume of the permeate stream 34, the size of the purification step 50 can be reduced by as much as about 50-70% compared with the FGD units traditionally required to treat the entire flue gas, stream 27, thereby providing significant savings on capital and operating costs.

A CO₂ gas stream 37 comprising at least about 50-80% (v/v) CO₂ for example, 60% (v/v) CO₂, exits the purification step 50 is then directed to downstream processes. As the purification step 50 occurs after the membrane separation step 30, there is still no fouling of the membrane due to the production of gypsum particles.

It is envisaged that the method of this invention is capable of being adapted to existing plants, without the need for costly changes to the design or performance of the combustion process or steam generation. It would be understood by a person skilled in the art that where oxygen enrichment is being incorporated into an existing plant, the oxygen enrichment of the feed gas stream 12 needs to be controlled in order to avoid detrimental effects to existing boilers or to avoid having to make expensive changes to the existing combustion system in the boilers. Thus, for the process to be adapted to an existing power plant, for example, the oxygen content in the feed gas stream 12 would be likely to be capped to within the range of about 25 to 35% v/v. This would result in a reduction in the volume of exhaust gas 22 produced, by about 10 to 25%

For new plants, the oxygen enrichment process can be designed to increase the oxygen content in the gas stream 12 to much higher levels, for example 40% v/v or more, as it would be feasible to incorporate appropriate combustors at the time of designing the plant. An increase in oxygen content in the feed gas stream 12 equated to as much as a 50% reduction in the volume of exhaust gas 22 produced, which then translates to smaller equipment size for the downstream treatment processes and less energy consumption.

It is understood that an advantage of the method of the present invention is that the combustion temperature is controlled by the oxygen enrichment process, thus recycling of a reject gas stream as a sweep gas is not required, as is demonstrated in methods of the prior art.

Unlike the prior art methods, the CO₂ content in the exhaust gas stream 22 does not need to be high in order to achieve efficient recovery, that is, there is no need to pre-concentrate the exhaust gas stream 22 by recirculating it back to the combustion process 20. The membrane system of the method of the present invention is capable of efficiently recovering CO₂ from an exhaust gas stream which has an overall concentration of CO₂ less than 10%.

It is understood that other impurities, such as hydrogen chloride, ammonia, or mercury may also separated from the exhaust gas by the first membrane separation step 30.

It is understood that the present invention, as depicted in FIG. 1, uses a membrane construction in the first membrane separation system 30 which is optimised to handling dusty streams, eg a spiral wound construction is preferred, and that the membrane construction used in the purification step 50 does not have to deal with dusty streams, and therefore a hollow fibre construction is preferred since this offers the highest membrane area to volume ratio allowing greater membrane area for CO₂ purification.

It is also understood a particular advantage of the present invention, as depicted in FIG. 1, relies upon using a membrane in the first membrane separation system 30 which has high permeability for CO₂ but a lower selectivity for CO₂ over N₂ compared to the membranes used in the purification step 50. High Permeability for CO₂ in the first membrane separation system 30, will typically result in a sacrifice of selectivity for CO₂ over N₂. This means that the membrane in the first membrane separation system 30 will capture all or most of the CO₂ but at the same time will also allow a higher portion of the N₂ and possibly other gases like oxygen to pass through into the permeate with the CO₂, compared to the purification step 50. The first membrane separation system 30 is also capable of separating other constituents such as SOₓ and NOₓ and water vapour. The membranes used in the first membrane separation system 30 therefore have a permeability for these gases of between about 100 to 50,000 Barrer.

This arrangement provides the opportunity to use a lower cost membrane material in the first stage membrane process 30, compared to the membrane material used in the purification step 50. An additional benefit of using a higher permeability membrane in the first membrane system 30 is to reduce the membrane area required to capture the CO₂ and therefore helps reduce the footprint and capital cost of the plant. This is an important aspect of the process since the first membrane stage will treat the largest volume of flue gas.

One significant advantage of the present invention is the use of a first membrane separation system 30 utilising high permeability/low selectivity membranes having a flat sheet or spiral wound construction, which is a design well suited to dealing with the dust and particulates in the gas 27. Substantially all of the dust and particulates are rejected, as well as a significant portion of the N₂, into stream 32, while simultaneously concentrating the CO₂ into the pre-concentrated gas stream 34.

It is envisaged that in some circumstances tubular, hollow fibre, or ceramic construction membranes can also used in the first membrane separation system 30, depending on the gas composition in stream 27, for example, dust loading may be low or absent as would be the case for exhaust gas from a gas fired power station, or the gas volume to be treated is small, or due to downstream process requirements.

Hollow fibre membranes are preferred for the purification step 50, as they are more prone to fouling by dust. Therefore, they are better suited for use once the pre-concentrated gas stream 34 has been “cleaned” and dust particles removed. It is understood that hollow fibre membranes may have a higher flow resistance compared to other membrane constructions such as spiral wound membranes, so operating costs would be higher. That is, the system would need more energy to pump gas through the membranes. However, given the volume of the pre-concentrated gas stream 34 has been significantly reduced, the net effect on operating expenditure is reduced. For the same reason, i.e. the reduced volume of the gas stream 34, capital costs for the second membrane stage 50 can also be minimised.

It is envisaged that overall process could comprise either the same membrane materials in each stage, or different membrane materials in each stage.

The process ideally uses different membrane constructions in combination, for example the first membrane separation system 30 may use a spiral wound membrane construction, and the purification step 50, a hollow fibre membrane construction, or it could employ a spiral wound construction followed by flat sheet or tubular, etc. Alternatively, the same membrane constructions could be used for both the first membrane separation system 30 and the purification step 50.

It is understood that the amount of water vapour present in the exhaust gas stream 27, which in itself is a greenhouse gas, is captured in the pre-concentrated gas stream 34 and can have an impact on the final volume of gas collected. However, after cooling the pre-concentrated gas stream 34 condensed water drops out and the volume of the final purified gas stream 37 is reduced even further.

It is envisaged that condensed water vapour, in certain arid areas could be a valuable resource that can be recovered and reused as process and or irrigation water from membrane based flue gas separation systems.

It is also understood that cooling the pre-concentrated gas stream 34 enables the use of more cost effective materials of construction in the purification step 50, For example, if the pre-concentrated gas stream 34 is cooled to below 50° C. then plastic piping can be used, such as PVC or HDPE (high density poly ethylene) or similar low cost materials. The plastic pipes can also reduce corrosion issues associated with the presence of SO₂ in the flue gas which produces sulphuric acid, and CO₂, which can produce carbonic acid.

It is envisaged that the gas feeding the first membrane stage, 27 could also be cooled sufficiently to allow plastic piping to be used in the construction of the first membrane stage 30, such as PVC or HDPE (high density poly ethylene) or similar low cost materials. This option would reduce capital costs for the first membrane stage by reducing the volume of gas to be treated and thereby reducing the size of piping and potentially also the membrane area required, and also by allowing the use of less expensive construction materiel for piping, valving, and ducting etc, and also reducing corrosion issues associated with the presence of SO₂ and CO₂ in the flue gas. This option also has the added advantage of reducing the costs of the membranes by allowing cheaper membrane backing support materials to be used for the first membrane separation system 30, i.e. polyethylene or PVC can be used instead of more expensive high temperature resistant backing supports such as Teflon, polysulfone, PVDF or inorganic materials.

It is also understood that the gas feeding the first membrane stage, 27 could be dehydrated to remove the majority of the water in the gas stream before feeding the gas to the first membrane separation system 30. This would also cool the feed gas 27 sufficiently to allow plastic piping to be used in the construction of the first membrane stage 30.

It is envisaged that the embodiments as described in FIGS. 3 and 4 can be combined to form a single process including all features of a first membrane separation step 30, an intermediate CO₂ recovery step 60, and a first and second purification steps 50 and 70.

It is understood that in conjunction with, or as an alternative to, positive displacement pumps (blowers), the gas streams 27 and 37 may be drawn through the first membrane separation system 30 and the purification system 50, under vacuum.

The method of the present invention is most economically performed at low pressures, for example, between about 1 to 10 bar. However, it is understood that both the first membrane separation stage 30 and the purification stages 50 and 70 can be operated at up to about 100 bar. At lower pressures relatively inexpensive materials can be used which will allow for a low cost design.

It is understood that the use of a membrane having an inorganic substrate or a high temperature polymer substrate is particularly advantageous as it significantly improves the temperature tolerance of the membrane. Thus, the method of the present invention does not require the exhaust gas to pass through a cooling and/or desulphurisation step prior to CO₂ separation. This is particularly beneficial as it reduces the instance of membrane fouling due to gypsum produced in, for example an FGD process.

An advantage of the present invention is that the use of spiral membranes in the first membrane separation stage 30 will act as a further barrier to remove any particulates in the flue gas, over and above the gas particulate filters of the prior art, which are not 100% efficient in removing particulates from exhaust gas streams. As the membranes offer a physical barrier, substantially no dust or impurity particles pass through the membrane. Thus, the permeate gas stream 34 is very clean and in optimal condition to be processed through a purification step 50, containing hollow fibre membranes, to concentrate the CO₂.

As an added benefit the spiral membranes in the first membrane separation stage 30 will at the same time pre-concentrate the CO₂, and so reduce the volume of gas that the hollow fibre membranes in the purification step 50, are required to treat. This pre-concentration is not achievable through the use of conventional gas filters of the prior art.

It is understood that the design of the membrane system must ensure the most suitable membrane construction is used which can deal with dusty and dirty gas streams, and which can be easily cleaned if the membranes do become fouled.

If the membranes do become fouled, then it will be critical that the membranes can be easily cleaned and returned to their previous clean operating state in a relatively short period of time. This would ideally involve an in-situ membrane cleaning and restoration process. An in-situ membrane cleaning and restoration process would be more easily established for a spiral wound membrane construction than a hollow fibre membrane construction; hence the reason why the 1^{st} membrane stage is preferably designed as a spiral wound membrane construction.

In some operating situations there is the potential that the dust loading to the membrane system can exceed the normal discharge limits. This can occur if there is a disturbance or upset upstream of the membrane system, eg in the combustion process 20 or in the dust removal process 26.

The membrane system must be robust enough to cope with such process excursions, i.e. the membrane system must be designed to deal with normal as well as upset process conditions. A spiral wound membrane system offers the most robust construction for dealing with this possible occurrence.

Membrane fouling issues will also be critical if the membrane separation system is installed downstream of an FGD (Flue Gas Desulphurisation) unit. In this case there is potential for gypsum particulates to be present in the flue gas. These could foul the membranes and therefore a suitable membrane system is required to deal with such fouling streams.

The use of spiral membrane constructions in the first membrane separation stage 30 offers significant benefits to deal with gas streams containing dust or particulates which may cause fouling compared to other membrane constructions, such as hollow fibre membranes.

The spiral membrane construction can be specifically engineered to deal with dusty or dirty streams, eg by selecting a suitable feed channel spacing and feed channel separation material so that the membranes are less prone to fouling. Plus spiral wound membrane constructions are easier to clean compared to other membrane constructions such as hollow fibre.

It is understood that the process of the present invention minimises the problems associated with particulate fouling of the membranes, associated with the treatment of exhaust and flue gas streams.

It is understood that where downstream processes do not require high purity CO₂ streams (for example >60% v/v) then the pre-concentrated gas stream may be immediately directed to these downstream processes without undergoing a purification step.

Downstream processes include but are not limited to algae farms for the production of biodiesel, a sodium carbonate/bicarbonate scrubbing processes to remove CO₂, or an FGD process to produce CaSO₄.2H₂O (gypsum) which can be sold as a building material, or an ammonia scrubbing process to remove SOₓ and NOx and produce ammonium sulphate and ammonium nitrate which can be used as fertiliser, or to other processes to produce pure CO₂ such as cryogenic distillation or chemical absorption systems such as the amine absorption process or physical adsorption systems such as Pressure Swing Adsorption (PSA).

It is also envisaged that industrial processing plants located nearby may have a use for the reject gas stream 32 as a blanketing gas to prevent explosions.

Where the CO₂ separation step 30 is introduced into existing plants already having an FGD step treating the main flue gas stream 27, it is envisaged that this FGD step may not be required or will have a significantly lower scrubbing load as a result of the combined membrane separation system 30 and FGD step 50 shown in FIG. 5.

It is still further envisaged that other oxygen enrichment processes could be used in place of the O₂ enrichment membrane/s 14, including pressure swing adsorption systems or cryogenic systems.

A further advantage of the present invention is that it removes water vapour from the exhaust gas stream 27. It has been suggested that in addition to carbon dioxide, the release of water vapour into the atmosphere may also contribute to global warming. The method of the present invention provides for the capture of water vapour, reducing emissions and providing a purified water stream, which can be recirculated for reuse.

It is understood that the method of the present invention results in the production of products such as CO₂, algae, water, sulphuric acid, ammonium sulphate and ammonium nitrate, and possibly sodium carbonate, which can be on-sold and generate revenue.

It is understood that gas concentrations (particularly in the purified CO₂ stream) as discussed in this application, are based on “dry” gas composition.

It is understood that the method of the present invention allows high purity gas streams to be obtained due to the ability to achieve both good permeability (e.g. first membrane separation system) together with good selectivity (e.g. purification step), as opposed to simply one feature or another as per known gas treatment systems. This renders the overall process more robust to handling water and acid, can be utilised at higher temperatures (greater than 100° C.) without experiencing rapid degradation of membranes, and also provides for separation of other gas components to be utilised in side processes.

Modifications and variations such as would be apparent to the skilled addressee are considered to fall within the scope of the present invention.

### EXAMPLE 1

Example 1 demonstrates the application of a 2 stage membrane separation process as shown in FIG. 1. However, as the process was operated at room temperature, no gas cooling step was required. The feed gas stream, comprised a bottled gas mixture of 85% (v/v) N2, 10% (v/v) CO2, and 5% (v/v) O2 and was passed through a first membrane separation system, comprising one spiral wound polydimethyl siloxane membrane. The permeate stream, was collected using a vacuum pump, and pumped through a membrane purification system, comprising one spiral wound polydimethyl siloxane membrane. The final permeate (purified CO₂ stream), was collected using a second vacuum pump. Both membranes had a CO₂ permeability of approximately 4000 Barrer and a CO₂/N₂ selectivity of approximately 11. The 2 stage membrane separation step achieved approximately 86% CO₂ (v/v) purity, with a total CO₂ recovery of approximately 83%.

The results of this test are provided in Table 1.

TABLE 1

| | Stream No | | | | |
|---|---|---|---|---|---|
| | 27 | 34 | 32 | 55 | 53 |
| | Stream ID | | | | |
| | Flue | | | | |
| Composition | Gas | Stage 1 | Stage 1 | CO2 | Stage 2 |
| (Dry Gas) | Feed | Permeate | Reject Gas | Concentrate | Reject Gas |
| N₂ (Vol %) | 85.0% | 29.4% | 94.4% | 9.2% | 70.9% |
| CO₂ (Vol %) | 10.0% | 63.7% | 0.9% | 86.2% | 17.5% |
| O₂ (Vol %) | 5.0% | 6.9% | 4.7% | 4.6% | 11.6% |

### EXAMPLE 2

Example 2 demonstrates the application of a 2 stage membrane separation process as shown in FIG. 1. However, as the process was operated at room temperature, no gas cooling step was required. The feed gas, stream, comprised a bottled gas mixture of 85% (v/v) N₂, 10% (v/v) CO₂, and 5% (v/v) O₂ and was passed through a first membrane separation system, comprising one spiral wound polydimethyl siloxane membrane. The permeate, stream, was collected using a vacuum pump, and pumped through a membrane purification system comprising one hollow fibre polyimide membrane. The final permeate (purified CO₂ stream), was collected using a second vacuum pump. The polydimethyl siloxane membrane had a CO₂ permeability of approximately 4000 Barrer and a CO₂/N₂ selectivity of approximately 11, while the polyimide membrane had a CO₂ permeability of approximately 500 Barrer and a CO₂/N₂ selectivity of approximately 23. The 2 stage membrane separation step achieved approximately 93% CO₂ (v/v) purity, with a total CO₂ recovery over 89%.

The results of this test are provided in Table 2.

This example shows the benefit of utilising two different membrane constructions as well as using two different membrane materials, i.e. a spiral wound membrane followed by a hollow fibre membrane, as well as using a membrane in the purification step having a higher selectivity for CO₂/N₂ than the membrane in the first membrane separation step. The final CO₂ purity has been increased from 86% in Example 1 to 93% in this example.

TABLE 2

| | Stream No | | | | |
|---|---|---|---|---|---|
| | 27 | 34 | 32 | 55 | 53 |
| | Stream ID | | | | |
| | Flue | | | | |
| Composition | Gas | Stage 1 | Stage 1 | CO2 | Stage 2 |
| (Dry Gas) | Feed | Permeate | Reject Gas | Concentrate | Reject Gas |
| N₂ (Vol %) | 85.0% | 29.1% | 94.6% | 4.0% | 78.4% |
| CO₂ (Vol %) | 10.0% | 63.7% | 0.8% | 93.3% | 5.7% |
| O₂ (Vol %) | 5.0% | 7.2% | 4.6% | 2.7% | 16.0% |

### EXAMPLE 3

Example 3 demonstrates the application of a 2 stage membrane separation process as shown in FIG. 2, in which a slip stream of exhaust gas, from a natural gas fired combustion process was pumped through a first membrane separation system, comprising one spiral wound polydimethyl siloxane membrane. The permeate, was cooled in a gas cooler, upstream of a vacuum pump, and then pumped through a membrane purification system comprising one spiral wound polydimethyl siloxane membrane. The final permeate, was collected using a second vacuum pump. The reject gas from the membrane purification system, was recycled to the feed of the first membrane separation system.

Both membranes had a CO₂ permeability of approximately 4000 Barrer and a CO₂/N₂ selectivity of approximately 11. The 2 stage membrane separation step achieved approximately 92% CO₂ (v/v) purity in the final permeate stream, with a total CO₂ recovery over 90%.

The results of this test are provided in Table 3.

The results also demonstrate that the PDMS membranes were able to recover SO₂, NOₓ as well as water vapour from the exhaust gas and concentrate them into the final purified CO₂ stream. Total SO₂ recovery was over 85%, NOx recovery was approximately 55%, and approximately 43% of the water in the exhaust gas was also recovered from the feed gas.

TABLE 3

| | Stream No | | | | | |
|---|---|---|---|---|---|---|
| | 27 | 34 | 32 | 37 | 53 | 55 |
| | Stream ID | | | | | |
| Composition | Flue Gas | Stage 1 | Reject | Cooled | Gas | CO2 |
| (Wet Gas Basis) | Feed | Permeate | Gas | Permeate | Recycle | Concentrate |
| N₂ (Vol %) | 74.5% | 22.6% | 87.1% | 34.3% | 70.1% | 3.2% |
| CO₂ (Vol %) | 6.8% | 38.8% | 0.5% | 58.9% | 20.3% | 92.4% |
| O₂ (Vol %) | 2.6% | 2.4% | 2.7% | 3.6% | 6.2% | 1.3% |
| H₂O (Vol %) | 15.3% | 36.2% | 9.7% | 3.2% | 3.5% | 3.0% |
| SO₂ (ppm) | 72 | 583 | 6 | 753 | 32 | 1379 |
| NOx (ppm) | 452 | 1769 | 190 | 2282 | 491 | 3838 |

1-46. (canceled)

47. A method for the separation of gases comprising the method steps of:
(i) passing an exhaust gas stream containing CO₂ through a first membrane separation system to produce a pre-concentrated gas stream containing at least carbon dioxide and a reject stream; and
(ii) directing the pre-concentrated gas stream to at least one purification step to produce a purified CO₂ stream;
wherein sulphur-containing gases (SOₓ) are also substantially separated from the exhaust gas stream by the first membrane separation step into the pre-concentrated gas stream, and the purified CO, stream is substantially free of nitrogen gas.

48. A method according to claim 47, wherein the first membrane separation system further:
(i) separates nitrogen containing gases (NOₓ) and water vapour into the pre-concentrated gas stream;
(ii) comprises at least one membrane having a flat sheet or spiral wound constniction;
(iii) comprises at least one membrane having a CO₂ permeability within the range of 10 to 40,000 Barrer; or
(iv) comprises at least one membrane having a CO₂ permeability within the range of 100 to 20,000 Barrer.

49. A method according to claim 48, wherein the at least one membrane is:
(i) formed from any one or a blend of polysulfone, polyacetylene polysiloxane, poly-arylate, polycarbonate, poly(aryl ether), poly(aryl ketone) or polyimide;
(ii) an inorganic membrane in the form of a ceramic, or metal or metal oxide; or
(iii) formed from polydimethyl siloxane.

50. A method according to claim 48, wherein at least one membrane is in the form of a high temperature membrane suitable for use at temperatures above 120° C. and optionally is formed from a polymer membrane coated onto a high temperature tolerant substrate.

51. A method according to claim 48, wherein:
(i) 30% to 90% of the NOₓ present in the exhaust gas stream is separated into the pre-concentrated gas stream; or
(ii) 50% to 80% of the NOₓ present in the exhaust gas stream is separated into the pre-concentrated gas stream.

52. A method according to claim 48, wherein NOₓ comprises one or more of NO, N₂O and NO₂.

53. A method according to claim 47, wherein the purification step comprises at least one membrane.

54. A method according to claim 53, wherein the at least one membrane has:
(i) a selectivity for CO₂ over nitrogen, within the range of 4 to 200;
(ii) a selectivity for CO₂ over nitrogen within the range of 8 to 100; or
(iii) a hollow fibre construction.

55. A method according to claim 47, wherein the purification step is operated at a temperature of less than 100° C.

56. A method according to claim 47, wherein the purified CO₂ stream contains:
(i) 70%-99% (v/v) CO₂; or
(ii) 90%-95% (v/v) CO₂.

57. A method according to claim 47, wherein the first membrane separation system retains:
(i) between 95%-100% of dust and particulate matter contained in the exhaust gas stream;
(ii) 99% of dust and particulate matter contained in the exhaust gas stream;
(iii) at least 50% of the nitrogen (N₂) contained in the exhaust gas stream; or
(iv) between 60% to 90% of the nitrogen contained in the exhaust gas stream into a reject stream.

58. A method according to claim 47, wherein the temperature of the exhaust gas passing through the first membrane separation system is within the range of:
(i) 50° C. and 300° C.; or
(ii) 120° C. and 250° C.

59. A method according to claim 47, wherein the exhaust gas stream:
(i) has a CO₂ concentration in the exhaust gas stream within the range of 1% and 50% (v/v);
(ii) has a CO, concentration within the range of 2% and 20% (v/v);
(iii) has 70% to 95% of the CO, present separated into the pre-concentrated gas stream;
(iv) has at least 90% of the CO, present separated into the pre-concentrated gas stream;
(v) has 70% to 99% of the SOx present separated into the pre-concentrated gas stream;
(vi) has 90% to 95% of the SOx present separated into the pre-concentrated gas stream;
(vii) has 30% to 90% of the water vapour in the exhaust gas is separated into the pre-concentrated gas stream;
(viii) has 40% to 80% of the water vapour present in the exhaust gas is separated into the pre-concentrated gas stream; or
(ix) is a flue gas.

60. A method according to claim 47, wherein SOx is predominantly comprised of SO₂.

61. A method according to claim 47, wherein the pre-concentrated gas stream:
(i) has a volume within the range of 20% to 40% of the original exhaust gas volume; or
(ii) is directed to a gas cooling step prior to the purification step.

62. A method according to claim 47, wherein the method further comprises:
(i) combusting a gas in a combustor in the presence of a fuel to produce the exhaust gas stream; or
(ii) enriching the oxygen content of a combustion gas entering a combustor to form an enriched oxygen stream and combusting the combustion gas in the presence of a fuel to produce the exhaust gas stream.

63. A method according to claim 62, wherein the fuel is a carbon-containing fuel.

64. A method according to claim 62, wherein the oxygen enrichment of step (ii):
(i) is performed using a secondary membrane system;
(ii) raises the concentration of oxygen to within the range of 22% to 50% (v/v); or
(iii) raises the concentration of oxygen to within the range of 22% to 40% (v/v).
